(19) United States
(12) Patent Application Publication
(10) Pub. No.: US 2021/0070318 A1
(43) Pub. Date: Mar. 11, 2021

(54) INTELLIGENT DRIVING CONTRL METHOD AND APPARATUS, AND COMPUTER STORAGE MEDIUM

(71) Applicant: SENSETIME GROUP LIMITED, Hong Kong (CN)

(72) Inventors: Guangliang Cheng, Hong Kong (CN); Jianping Shi, Hong Kong (CN)

(21) Appl. No.: 17/101,918

(22) Filed: Nov. 23, 2020

Related U.S. Application Data
(63) Continuation of application No. PCT/CN2019/108282, filed on Sep. 26, 2019.

(30) Foreign Application Priority Data
Jun. 19, 2019 (CN) 201910531192.1

(51) Int. Cl. B60W 60/00; G06K 9/00; B60W 10/04; B60W 10/18; B60W 50/06; G06N 3/04; G06N 3/08

(52) U.S. Cl. CPC B60W 60/001; G06K 9/00791; B60W 10/04; B60W 10/18; B60W 2552/05; G06N 3/04; G06N 3/08; B60W 2420/42; B60W 50/06

(57) ABSTRACT

An intelligent driving control method and apparatus, and a computer storage medium are provided The method includes: obtaining a pavement image of a pavement on which a vehicle travels; determining a category of a pavement scene in the pavement image according to the obtained pavement image; and performing an intelligent driving control on the vehicle according to the determined category of the pavement scene.

### CROSS REFERENCE TO RELATED APPLICATIONS

This application is a continuation of International Patent Application No. PCT/CN2019/108282, filed on Sep. 26, 2019, which claims priority to Chinese Patent Application No. 201910531192.1, filed on Jun. 19, 2019. The disclosures of International Patent Application No. PCT/CN2019/108282 and Chinese Patent Application No. 201910531192.1 are hereby incorporated by reference in their entireties.

### BACKGROUND

In recent years, the computer vision technology has developed rapidly, and people can use trained neural networks to perform various visual tasks, such as image classification, object tracking, and face recognition. On the other hand, with the improvement of assisted driving and automatic driving techniques, more and more demands related to the assisted driving and automatic driving have been proposed.

### SUMMARY

The present disclosure relates to a computer vision technology. The embodiments of the present disclosure provide an intelligent driving control method and apparatus, an electronic device, a computer program, and a computer storage medium.

The intelligent driving control method provided by the embodiments of the present disclosure includes: obtaining a pavement image of a pavement on which a vehicle travels; determining a category of a pavement scene in the pavement image according to the obtained pavement image; and performing an intelligent driving control on the vehicle according to the determined category of the pavement scene.

The intelligent driving control apparatus provided by the embodiments of the present disclosure includes: a processor; and a memory, configured to store instructions executable by the processor; where processor is configured to execute the instructions to implement the intelligent driving control method as described above.

The computer storage medium provided by the embodiments of the present disclosure is configured to store computer readable instructions, where the instructions, when being executed, cause to implement the intelligent driving control method as described above.

Based on the intelligent driving control method and apparatus, the electronic device, the computer program, and the computer storage medium provided by the above-described embodiments of the present disclosure, a pavement image of a pavement on which a vehicle travels is obtained, a pavement scene in the obtained pavement image is identified, thereby determining a category of the pavement scene in the pavement image, and the intelligent driving control on the vehicle is implemented based on the determined category of the pavement scene.

### BRIEF DESCRIPTION OF DRAWINGS

FIG. 1 is a schematic flowchart of an intelligent driving control method provided by the embodiments of the present disclosure.

FIG. 2 is a schematic diagram of various categories of pavement scenes provided by the embodiments of the present disclosure.

FIG. 3 is another schematic flowchart of the intelligent driving control method provided by the embodiments of the present disclosure.

FIG. 4A is a principle diagram of an identification of the categories of pavement scenes provided by the embodiments of the present disclosure.

FIG. 4B is another principle diagram of the identification of the categories of pavement scenes provided by the embodiments of the present disclosure.

FIG. 4C is a structural diagram of a neural network provided by the embodiments of the present disclosure.

FIG. 5 is a schematic structural composition diagram of an intelligent driving control apparatus provided by the embodiments of the present disclosure.

FIG. 6 is a schematic structural composition diagram of an electronic device provided by the embodiments of the present disclosure.

### DETAILED DESCRIPTION

Various exemplary embodiments of the present disclosure are now described in detail with reference to the accompanying drawings. It should be noted that a relative arrangement of components, numerical expressions, and values set forth in the embodiments are not intended to limit the scope of the present disclosure, unless otherwise specifically noted.

The following descriptions of at least one exemplary embodiment are merely illustrative actually, and are not intended to limit the present disclosure and applications or uses thereof in any way.

Technologies, methods and devices known to a person of ordinary skill in the related art may not be discussed in detail, but such technologies, methods and devices should be considered as a part of the specification in appropriate situations.

It should be noted that similar reference numerals and letters in the following accompanying drawings represent similar items. Therefore, once an item is defined in an accompanying drawing, the item does not need to be further discussed in the subsequent accompanying drawings.

The embodiments of the present disclosure may be applied to computer systems/servers, which may operate with numerous other general-purpose or special-purpose computing system environments or configurations. Examples of well-known computing systems, environments, and/or configurations suitable for use together with the computer systems/servers include, but not limited to, personal computer systems, server computer systems, thin clients, thick clients, handheld or laptop devices, microprocessor-based systems, set top boxes, programmable consumer electronics, network personal computers, small computer systems, large computer systems, distributed cloud computing environments that include any one of the foregoing systems, and the like.

In the process of implementing the technical solutions of the embodiments of the present disclosure, the applicant finds at least the following problem: when driving, the driver needs to determine his/her own driving speed and braking strength according to different pavement scenes. For example, on a normal pavement, it is easier for the driver to make a braking action in case of an emergency and stop the vehicle more smoothly, even if the driver is traveling at a higher speed. However, when it rains, the driver cannot drive too fast. Accidents such as rollover occur during braking due to the slippery ground, and thus a relatively small friction coefficient, and sometimes a rear-end collision occurs due to an untimely braking.

It is necessary for the driver to drive very slowly, and of course take extra care during braking too, in severe cases such as on a snowy icy pavement. In the above-described situations, there may be several difficult problems even with a better-skilled driver. In order to solve the above-described problems, technical solutions of the embodiments of the present disclosure are proposed. The technical solutions of the embodiments of the present disclosure intend to distinguish different pavement scenes, identify the current pavements accurately. This provides accurate driving strategies for the assisted driving and automatic driving, ensuring safety during the driving of the vehicle.

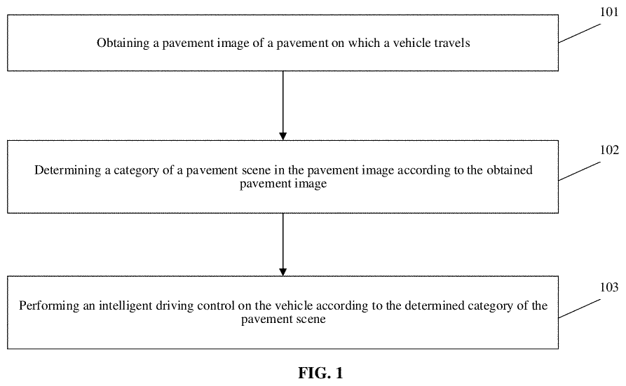

FIG. 1 is a schematic flowchart of an intelligent driving control method provided by the embodiments of the present disclosure. As shown in FIG. 1, the intelligent driving control method includes the following operations.

At block 101, a pavement image of a pavement on which a vehicle travels is obtained.

In the embodiments of the present disclosure, the pavement image may be an image directly acquired from an image capturing device such as a camera or the like, or may be an image acquired from another device. The way the pavement image is obtained is not limited by the present embodiments.

In some optional implementations, the pavement image of the pavement on which the vehicle travels is acquired by the image capture device disposed on the vehicle.

At block 102, a category of a pavement scene in the pavement image is determined according to the obtained pavement image.

In the embodiments of the present disclosure, there are two different situations for the category of pavement scene. In the first situation, there are different roads, that is, different geographical locations where the roads are located, different coverings on the roads, for example, an asphalt pavement, a cement pavement, a desert pavement, a dirt pavement, etc. In the second situation, there are same roads, but the environment in which the roads are located changes, resulting in different coverings on the roads, such as a slippery pavement, an icy pavement, a snowy pavement, etc.

At block 103, the intelligent driving control is performed on the vehicle according to the determined category of the pavement scene.

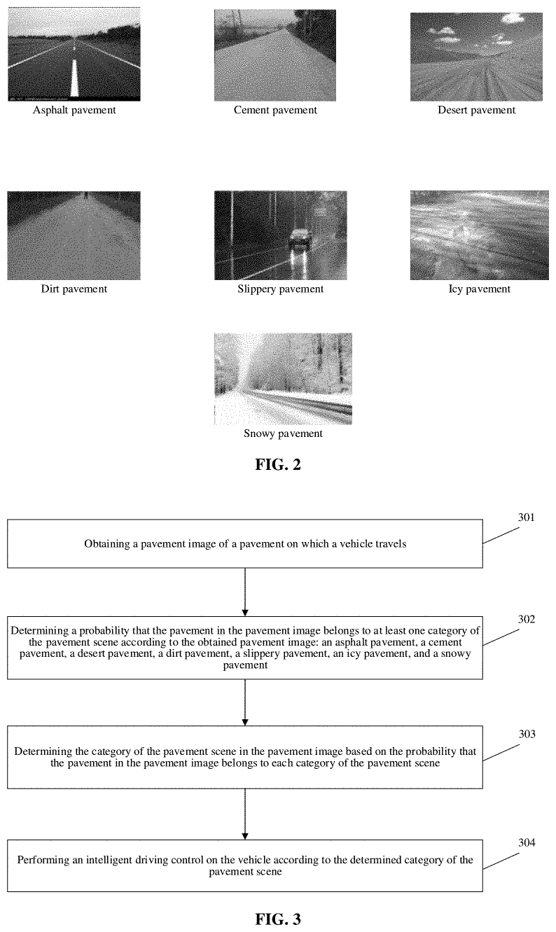

The embodiments of the present disclosure define a new classification task, that is, a classification task of the pavement scene. Referring to FIG. 2 for the classification task of the pavement scene, the embodiments of the present disclosure clearly define at least one category of the pavement scene as follows: an asphalt pavement, a cement pavement, a desert pavement, a dirt pavement, a slippery pavement, an icy pavement, and a snowy pavement. Of course, there may also be other situations for the pavement scene, which is not limited in the present disclosure.

In the embodiments of the present disclosure, the intelligent driving control may be performed on the vehicle according to the category of the pavement scene after the category of the pavement scene in the pavement image is obtained through the above-described operations 101 and 102. Herein, the intelligent driving control of the vehicle may be applied to an automatic driving scene, and may also be applied to an assist driving scene.

For example, in the automatic driving scene, a speed control parameter and/or braking force control parameter of the vehicle is determined according to the determined category of the pavement scene, and a driving component and/or braking component of the vehicle is controlled according to the determined speed control parameter and/or braking force control parameter of the vehicle, thereby the driving speed of the vehicle is controlled according to the pavement scene to improve driving safety.

For example, in the assist driving scene, prompt information is output according to the determined category of the pavement scene. The prompt information comprises at least one of the following information: the speed control parameter of the vehicle, the braking force control parameter of the vehicle, and warning information.

This allows the driver to make correct driving decisions through the prompt information, improving driving safety. For example, the driving speed of the vehicle is adjusted with reference to the prompted speed control parameter and/or braking force control parameter of the vehicle, or when the vehicle is driving fast on a dangerous pavement (such as a slippery pavement, an icy pavement, or a snowy pavement, etc.), the driver is prompted to refer to the prompted speed control parameter and/or braking force control parameter of the vehicle, or an warning information is directly sent to prompt the driver to reduce the speed. Herein, the prompt information may be at least one of a voice message, a text message, an animation message, or an image message. The implementation manner of the prompt information is not limited in the embodiments of the present disclosure. Optionally, the prompt information is a voice message, so that the driver does not need to pay extra attention to the prompt information.

The speed control parameters and braking force control parameters corresponding to seven different categories of pavement scenes respectively are given in table 1, where the speed control parameters are used to indicate the recommended maximum operating speed of the vehicle, and the braking force control parameters are used to indicate the braking force available to the vehicle.

TABLE 1

| Category of | Speed Control | Braking Force |
|---|---|---|
| Pavement Scene | Parameter (km/h) | Control Parameter |
| Asphalt pavement (dry) | 100 | High or Medium |
| Cement pavement (dry) | 80 | High or Medium |
| Desert pavement | 80 | Medium |
| Dirt pavement | 80 | Medium |
| Slippery pavement | 60 | Medium or Low |
| Icy pavement | 40 | Weak |
| Snowy pavement | 60 | Medium or Low |

The technical solutions of the embodiments of the present disclosure identify the pavement scene in the obtained pavement image of the pavement on which the vehicle travels, thereby determining the category of the pavement scene in the pavement image, and achieving the intelligence driving control on the vehicle based on the determined category of the pavement scene.

FIG. 3 is another schematic flowchart of the intelligent driving control method provided by the embodiments of the present disclosure. As shown in FIG. 3, the intelligent driving control method includes the following operations.

At block 301, a pavement image of a pavement on which a vehicle travels is obtained.

In the embodiments of the present disclosure, the pavement image may be an image directly acquired from an image capturing device such as a camera or the like, or may be an image acquired from another device. The way the pavement image is obtained is not limited by the present embodiments.

At block 302, a probability that the pavement in the pavement image belongs to at least one category of pavement scene is determined according to the obtained pavement image. The at least one category of pavement scene includes: an asphalt pavement, a cement pavement, a desert pavement, a dirt pavement, a slippery pavement, an icy pavement, and a snowy pavement.

At block 303, a category of a pavement scene in the pavement image is determined based on the probability that the pavement in the pavement image belongs to each category of the pavement scene.

The category of the pavement scene in the pavement image is determined based on the probability that the pavement in the pavement image belongs to each category of the pavement scene after the probability that the pavement in the pavement image belongs to each category of the pavement scene is determined. In some optional implementations of the present disclosure, the category of the pavement scene with the highest probability is taken as the category of the pavement scene to which the pavement in the pavement image belongs.

In some optional implementations of the present disclosure, a neural network is utilized to determine the category of the pavement scene in the pavement image, where any of the neural networks used for the classification task can be used to determine the category of the pavement scene in the pavement image. The network structure of the neural network is not limited by the embodiments of the present disclosure. For example, a residual network structure, or a VGG16 network structure, etc. is used in the neural network.

The technical solutions of the embodiments of the present disclosure are not limited to the determination of the category of the pavement scene in the pavement image using the neural network, and a non-neural network classifier may also be used to determine the category of the pavement scene in the pavement image, where the non-neural network classifier is, for example, a Support Vector Machine (SVM) classifier, a Random Forest classifier, and the like.

In the embodiments of the present disclosure, the neural network is utilized to determine the category of the pavement scene in the pavement image, which may be implemented as follows.

In the first manner, the obtained pavement image is input into the neural network, and the neural network is utilized to determine the category of the pavement scene in the pavement image, where the neural network is trained by using an image set composed of the pavement images marked with the category of the pavement scene.

In particular, the image set is used to perform a supervised training on the neural network before the neural network is used to determine the category of the pavement scene in the pavement image. The pavement image in the image set has been marked with the category of the pavement scene in the pavement image. In some optional implementations, the supervised training is performed on the neural network in the following ways: inputting the pavement image in the image set as a sample image into the neural network, the sample image being marked with the category of the pavement scene; utilizing the neural network to determine a probability that the pavement in the sample image belongs to at least one category of pavement scene: an asphalt pavement, a cement pavement, a desert pavement, a dirt pavement, a slippery pavement, an icy pavement, and a snowy pavement; predicting the category of the pavement scene in the sample image based on the probability that the pavement in the pavement image belongs to each category of the pavement scene; calculating a value of a loss function based on the predicted category of the pavement scene in the sample image and the marked category of the pavement scene of the sample image; identifying whether the value of the loss function satisfies a preset condition; adjusting parameters of the neural network based on the value of the loss function, in response to the value of the loss function not satisfying the preset condition, and then performing iteratively an operation utilizing the predicted category of the pavement scene in the sample image, until the value of the loss function satisfies the preset condition, and the training on the neural network is completed.

After the completion of the training on the neural network, the trained neural network is utilized to determine the probability that the pavement in the pavement image belongs to at least one category of the pavement scene: an asphalt pavement, a cement pavement, a desert pavement, a dirt pavement, a slippery pavement, an icy pavement, and a snowy pavement; the category of the pavement scene in the pavement image is determined, by the trained neural network, based on the probability that the pavement in the pavement image belongs to each category of the pavement scene. For example, the category of the pavement scene with the highest probability is taken as the category of the pavement scene to which the pavement in the pavement image belongs.

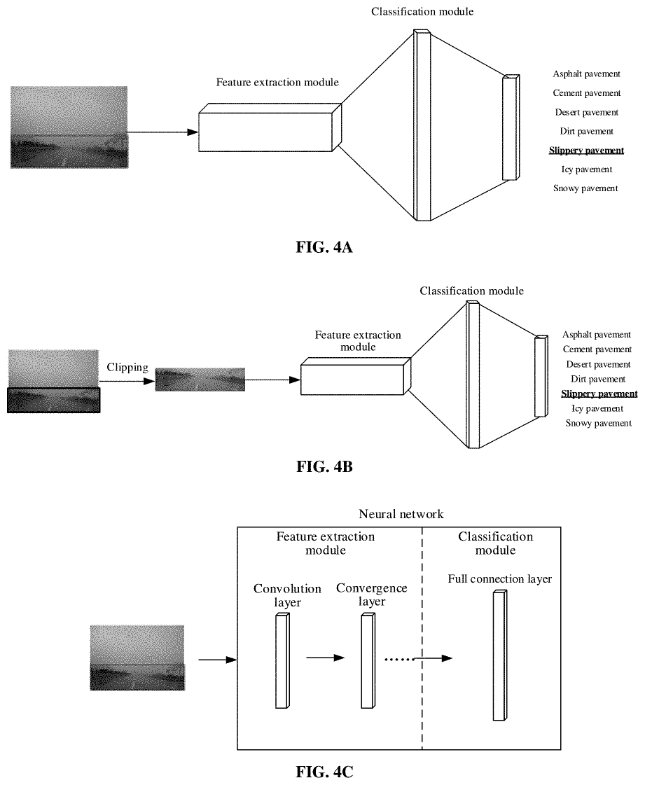

Referring to FIG. 4A, the neural network includes, as a whole, a feature extraction module and a classification module. In an optional implementation, the feature extraction module is composed of a convolution layer, and the classification module is composed of a full connection layer. The feature extraction module is used to extract features in the pavement image to generate feature vectors with certain dimensions. The classification module is used to classify the above-described feature vectors, that is, to map the above-described feature vectors to the probability corresponding to N categories of the pavement scenes, taking N=7 as an example in FIG. 4A, to finally obtain the probability that the pavement in the pavement image belongs to an asphalt pavement, a cement pavement, a desert pavement, a dirt pavement, a slippery pavement, an icy pavement and a snowy pavement, respectively. Hereafter, the category of the pavement scene with the highest probability is taken, by the neural network, as the category of the pavement scene to which the pavement in the pavement image belongs. As shown in FIG. 4A, there is a highest probability that the pavement in the pavement image belongs to the slippery pavement, and thus the pavement in the pavement image is identified, by the neural network, as the slippery pavement.

In the second manner, the obtained pavement image is clipped to obtain a clipped pavement image, before the category of the pavement scene in the pavement image is determined according to the obtained pavement image, where the proportion of the pavement on which the vehicle travels to the clipped pavement image is greater than the proportion of the pavement on which the vehicle travels to the obtained pavement image. Then the category of the pavement scene in the pavement image is determined according to the clipped pavement image. In particular, the clipped pavement image is input into the neural network, and the neural network is utilized to determine the category of the pavement scene in the pavement image, where the neural network is trained by using an image set composed of the pavement images marked with the category of the pavement scene.

In particular, the obtained pavement image is clipped to obtain a clipped pavement image, and the clipped pavement image is input into the neural network, and the neural network is utilized to determine the probability that the pavement in the clipped pavement belongs to at least one category of the pavement scene: an asphalt pavement, a cement pavement, a desert pavement, a dirt pavement, a slippery pavement, an icy pavement, and a snowy pavement. The category of the pavement scene in the pavement image is determined, by the neural network, based on the probability that the pavement in the pavement image belongs to each category of the pavement scene.

Referring to FIG. 4B, a clipping step is added relative to FIG. 4A since some misclassifications occur when the pavement images are classified due to the fact that some areas of the pavement image are independent of the pavement (for example, the upper part of the pavement image is a big sky). Therefore, the pavement image is clipped before the pavement image is identified, and the proportion of the pavement occupying the pavement image obtained after clipping increases. In one implementation, 40% of the area above the bottom edge of the pavement image may be clipped out as an input to the neural network. The neural network in the second manner can adopt the same structure as the neural network in the first manner. In particular, for the process of processing the clipped pavement image by the neural network in the second manner, reference may be made to the process of processing the pavement image by the neural network in the first manner, which is not repeatedly described here.

In the above-described FIG. 4A and FIG. 4B, the structure of the neural network generally includes a feature extraction module and a classification module. Where, the feature extraction module includes a convolution layer and a pooling layer. Further, the feature extraction module has, in addition to the convolution layer and the pooling layer, other layers interspersed between the convolution layer and the pooling layer, which function to reduce over-fitting, improve the learning rate, and mitigate the vanishing gradient problem, etc. For example, the feature extraction module may further include a dropout layer that prevents over-fitting of the neural network. For another example, the feature extraction module may further include an excitation layer (such as a ReLU layer). One excitation layer is connected behind each convolution layer, and the excitation layer functions to add a nonlinear factor. The classification module includes a full connection layer, the input of which being an output of the feature extraction module. The full connection layer is to map the feature data of the pavement image to each pavement scene, thereby obtaining the probability that the pavement in the pavement image belongs to each category of the pavement scene. FIG. 4C gives a structural diagram of an optional neural network. It should be noted that the number of layers included in the neural network is not limited in the present disclosure, and the structure of any neural network used for classification tasks can be used to achieve the classification of pavement scenes in pavement images.

At block 304, the intelligent driving control is performed on the vehicle according to the determined category of the pavement scene.

In the embodiments of the present disclosure, the intelligent driving control may be performed on the vehicle according to the category of the pavement scene after the category of the pavement scene in the pavement image is obtained through the above-described operations 301 to 302. Herein, the intelligent driving control of the vehicle may be applied to an automatic driving scene, and may also be applied to an assist driving scene. For the manner applied in the automatic driving scene, reference may be made to the automatic driving scene in the embodiment shown in FIG. 1, and for the manner applied in the assist driving scene, reference may be made to the assist driving scene in the embodiment shown in FIG. 1, which will not be not repeatedly described here.

The technical solutions of the embodiments of the present disclosure identify the pavement scene in the obtained pavement image of the pavement on which the vehicle travels, thereby determining the category of the pavement scene in the pavement image, and achieving the intelligence driving control on the vehicle based on the determined category of the pavement scene.

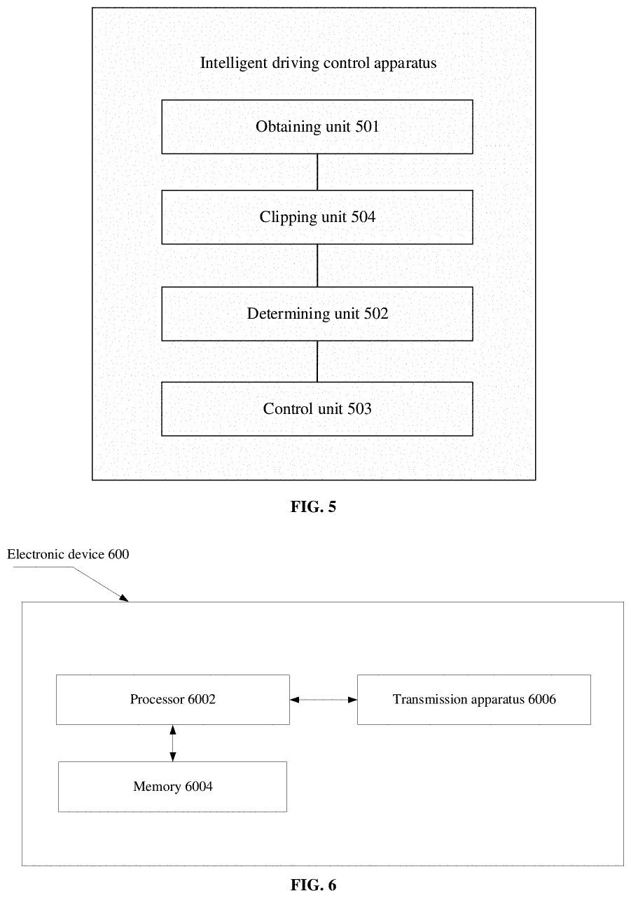

FIG. 5 is a schematic structural composition diagram of an intelligent driving control apparatus provided by the embodiments of the present disclosure. As shown in FIG. 5, the intelligent driving control apparatus includes:

an obtaining unit 501, configured to obtain a pavement image of a pavement on which a vehicle travels;

a determining unit 502, configured to determine a category of a pavement scene in the pavement image according to the obtained pavement image; and

a control unit 503, configured to perform an intelligent driving control on the vehicle according to the determined category of the pavement scene.

In some optional implementations of the present disclosure, the determining unit 502 is configured to determine, according to the obtained pavement image, a probability that the pavement in the pavement image belongs to at least one category of pavement scene: an asphalt pavement, a cement pavement, a desert pavement, a dirt pavement, a slippery pavement, an icy pavement, and a snowy pavement; determine the category of the pavement scene in the pavement image based on the probability that the pavement in the pavement image belongs to each category of the pavement scene.

In some optional implementations of the present disclosure, the control unit 503 is configured to determine a speed control parameter and/or braking force control parameter of the vehicle according to the determined category of the pavement scene; control a driving component and/or braking component of the vehicle according to the determined speed control parameter and/or braking force control parameter of the vehicle.

In some optional implementations of the present disclosure, the control unit 503 is configured to output prompt information according to the determined category of the pavement scene. The prompt information comprises at least one of the following information:

the speed control parameter of the vehicle, the braking force control parameter of the vehicle, and warning information.

In some optional implementations of the present disclosure, the determining unit 502 is configured to input the obtained pavement image into a neural network, and utilize the neural network to determine the category of the pavement scene in the pavement image, wherein the neural network is trained by using an image set composed of the pavement images marked with the category of the pavement scene.

In some optional implementations of the present disclosure, the apparatus further includes:

a clipping unit 504 configured to, before the category of the pavement scene in the pavement image is determined according to the obtained pavement image, clip the obtained pavement image to obtain a clipped pavement image; wherein the proportion of the pavement on which the vehicle travels to the clipped pavement image is greater than the proportion of the pavement on which the vehicle travels to the obtained pavement image;

the determining unit 502 configured to determine the category of the pavement scene in the pavement image according to the clipped pavement image.

It will be understood by those skilled in the art that the implementation function of each unit in the intelligent driving control apparatus shown in FIG. 5 can be understood by referring to the related description of the aforementioned intelligent driving control method. The function of each unit in the intelligent driving control apparatus shown in FIG. 5 may be realized by a program running on a processor, or may be realized by a specific logic circuit.

In the embodiments of the present disclosure, the above-described intelligent driving control apparatus may also be stored in a computer storage medium if it is implemented in the form of a software function module and sold or used as a stand-alone product. Based on such understanding, the technical solutions of the embodiments of the present disclosure essentially, or the part thereof contributing to the prior art, may be embodied in the form of a software product which is stored in a storage medium and includes several instructions to cause a computer device (which may be a personal computer, a server, or a network device, etc.) to perform all or part of the methods described in various embodiments of the present disclosure. The foregoing storage media include various media capable of storing program codes, such as, a U disk, a removable hard disk, a Read Only Memory (ROM), a magnetic disk, or a compact disk. In this way, the embodiments of the present disclosure are not limited to any specific combination of hardware and software.

Accordingly, in the embodiments of the present disclosure, there is further provided a computer program product having computer-readable codes stored therein that, when run on the processor, cause the processor in the device to perform the following operations:

obtaining a pavement image of a pavement on which a vehicle travels;

determining a category of a pavement scene in the pavement image according to the obtained pavement image;

performing an intelligent driving control on the vehicle according to the determined category of the pavement scene.

In some optional implementations of the present disclosure, when the computer readable codes are run on the device, the processor in the device performs the operation of determining the category of the pavement scene in the pavement image according to the obtained pavement image, including:

Determining, according to the obtained pavement image, a probability that the pavement in the pavement image belongs to at least one category of the pavement scene: an asphalt pavement, a cement pavement, a desert pavement, a dirt pavement, a slippery pavement, an icy pavement, and a snowy pavement;

determining the category of the pavement scene in the pavement image based on the probability that the pavement in the pavement image belongs to each category of the pavement scene.

In some optional implementations of the present disclosure, when the computer readable codes are run on the device, the processor in the device performs the operation of performing intelligent driving control on the vehicle according to the determined category of the pavement scene, including:

determining a speed control parameter and/or braking force control parameter of the vehicle according to the determined category of the pavement scene;

controlling a driving component and/or braking component of the vehicle according to the determined speed control parameter and/or braking force control parameter of the vehicle.

In some optional implementations of the present disclosure, when the computer readable codes are run on the device, the processor in the device performs the operation of performing intelligent driving control on the vehicle according to the determined category of the pavement scene, including:

outputting prompt information according to the determined category of the pavement scene; the prompt information comprises at least one of the following information:

the speed control parameter of the vehicle, the braking force control parameter of the vehicle, and warning information.

In some optional implementations of the present disclosure, when the computer readable codes are run on the device, the processor in the device performs the operation of determining the category of the pavement scene in the pavement image according to the obtained pavement image, including:

inputting the obtained pavement image into a neural network, and determining the category of the pavement scene in the pavement image by using the neural network, wherein the neural network is trained by using an image set composed of the pavement images marked with the category of the pavement scene.

In some optional implementations of the present disclosure, when the computer readable codes are run on the device, before performing the operation of determining the category of the pavement scene in the pavement image according to the obtained pavement image, the processor in the device further performs the following operations:

clipping the obtained pavement image to obtain a clipped pavement image; wherein the proportion of the pavement on which the vehicle travels to the clipped pavement image is greater than the proportion of the pavement on which the vehicle travels to the obtained pavement image;

when the computer readable codes are run on the device, the processor in the device performs the operation of determining the category of the pavement scene in the pavement image according to the obtained pavement image, including:

determining the category of the pavement scene in the pavement image according to the clipped pavement image.

FIG. 6 is a schematic structural composition diagram of an electronic device according to the embodiments of the present disclosure. As shown in FIG. 6, the electronic device 600 may include one or more (only one of which is shown) processor 6002 (the processor 6002 may include but not limited to processing devices such as a microprocessor (MCU, Micro Controller Unit) or a programmable logic device (FPGA), a memory 6004 for storing data, and optionally, a transmission apparatus 6006 for communication function. It will be understood by those skilled in the art that the structure shown in FIG. 6 is merely illustrative and does not limit the structure of the above-described electronic device. For example, the electronic device 600 may further include more or fewer components than shown in FIG. 6, or may have a different configuration than that shown in FIG. 6.

The memory 6004 may include a high speed random access memory, and may also include a non-volatile memory, such as one or more magnetic storage device, flash memory, or other non-volatile solid state memory. In some examples, the memory 6004 may further include memories remotely located relative to the processor 6002, which may be connected to the electronic device 600 over a network. Examples of the above-described networks include, but not limited to, the Internet, intranets, local area networks, mobile communication networks, and combinations thereof.

The transmission apparatus 6006 is used for receiving or transmitting data via a network. Specific examples of the above-described networks may include a wireless network provided by a communication provider of the electronic device 600. In one example, the transmission apparatus 6006 includes a Network Interface Controller (NIC) that may be connected to other network devices through a base station to communicate with the Internet. In one example, the transmission apparatus 6006 may be a Radio Frequency (RF) module for communicating with the Internet wirelessly.

The memory 6004 may be used to store executable instructions (which may also be referred to as software programs and modules), and the processor 6002 accomplishes the following operations by executing the executable instructions stored in the memory 6004:

obtaining a pavement image of a pavement on which a vehicle travels;

determining a category of a pavement scene in the pavement image according to the obtained pavement image;

performing an intelligent driving control on the vehicle according to the determined category of the pavement scene.

In some optional implementations of the present disclosure, the processor 6002 is configured to execute the executable instructions to complete the operation of determining a category of the pavement scene in the pavement image according to the obtained pavement image, including:

determining a probability that the pavement in the pavement image belongs to at least one category of the pavement scene according to the obtained pavement image, where the at least one category of pavement scene includes: an asphalt pavement, a cement pavement, a desert pavement, a dirt pavement, a slippery pavement, an icy pavement, and a snowy pavement;

determining the category of the pavement scene in the pavement image based on the probability that the pavement in the pavement image belongs to each category of the pavement scene.

In some optional implementations of the present disclosure, the processor 6002 is configured to execute the executable instructions to complete the operation of performing intelligent driving control on the vehicle according to the determined category of the pavement scene, including:

determining a speed control parameter and/or braking force control parameter of the vehicle according to the determined category of the pavement scene;

controlling a driving component and/or braking component of the vehicle according to the determined speed control parameter and/or braking force control parameter of the vehicle.

In some optional implementations of the present disclosure, the processor 6002 is configured to execute the executable instructions to complete the operation of performing intelligent driving control on the vehicle according to the determined category of the pavement scene, including:

outputting prompt information according to the determined category of the pavement scene; the prompt information comprises at least one of the following information:

the speed control parameter of the vehicle, the braking force control parameter of the vehicle, and warning information.

In some optional implementations of the present disclosure, the processor 6002 is configured to execute the executable instructions to complete the operation of determining the category of the pavement scene in the pavement image according to the obtained pavement image, including:

inputting the obtained pavement image into a neural network, and determining the category of the pavement scene in the pavement image by using the neural network, wherein the neural network is trained by using an image set composed of the pavement images marked with the category of the pavement scene.

In some optional implementations of the present disclosure, the processor 6002 is configured to, before performing the operation of determining the category of the pavement scene in the pavement image according to the obtained pavement image, execute the executable instructions to complete the following operations:

clipping the obtained pavement image to obtain a clipped pavement image; wherein the proportion of the pavement on which the vehicle travels to the clipped pavement image is greater than the proportion of the pavement on which the vehicle travels to the obtained pavement image;

The processor 6002 is configured to execute the executable instructions to complete the operation of determining the category of the pavement scene in the pavement image according to the obtained pavement image, including:

determining the category of the pavement scene in the pavement image according to the clipped pavement image.

The technical solutions described in the embodiments of the present disclosure can be arbitrarily combined in case of no conflict.

In the several embodiments provided by the present disclosure, it should be understood that the disclosed method and intelligent device may be implemented in other manners. The device embodiments described above are merely illustrative. For example, the division of the unit is only a logical function division. In actual implementation, there may be another division manner, for example, multiple units or components may be combined, or may be integrated into another system, or some features may be ignored or not executed. In addition, the displayed or discussed mutual coupling, or direct coupling, or communication connection between the components may be indirect coupling or communication connection through some interfaces, devices, or units, and may be electrical, mechanical, or in another form.

The units described above as separate components may or may not be physically separated, and the components shown as units may or may not be physical units, that is, may be located in one place, or may be distributed onto multiple network units. Part or all of the units may be selected according to actual needs to achieve the objectives of the solutions of the present embodiment.

In addition, each functional unit in each embodiment of the present disclosure may be integrated into one second processing unit, or each unit used as one unit separately, or two or more units integrated into one unit. The above-described integrated unit can be implemented in the form of hardware or in the form of hardware plus software functional units.

The foregoing is only a specific implementation of the present disclosure, but the scope of protection of the present disclosure is not limited thereto. Any person skilled in the art can easily think of changes or substitutions within the scope of the technology disclosed in the present disclosure, which should fall within the scope of protection of the present disclosure.

1. An intelligent driving control method, comprising:
obtaining a pavement image of a pavement on which a vehicle travels;
determining a category of a pavement scene in the pavement image according to the obtained pavement image; and
performing an intelligent driving control on the vehicle according to the determined category of the pavement scene.

2. The method according to claim 1, wherein the determining the category of the pavement scene in the pavement image according to the obtained pavement image comprises:
determining, according to the obtained pavement image, a probability that the pavement in the pavement image belongs to each of at least one category of pavement scene comprising:
an asphalt pavement, a cement pavement, a desert pavement, a dirt pavement, a slippery pavement, an icy pavement, and a snowy pavement; and
determining the category of the pavement scene in the pavement image based on the probability that the pavement in the pavement image belongs to each of the at least one category of pavement scene.

3. The method according to claim 1, wherein the performing the intelligent driving control on the vehicle according to the determined category of the pavement scene comprises:
determining at least one of a speed control parameter or a braking force control parameter of a vehicle according to the determined category of the pavement scene; and
controlling at least one of a driving component or braking component of the vehicle according to the determined at least one of speed control parameter or braking force control parameter of the vehicle.

4. The method according to claim 2, wherein the performing the intelligent driving control on the vehicle according to the determined category of the pavement scene comprises:
determining at least one of a speed control parameter or a braking force control parameter of a vehicle according to the determined category of the pavement scene; and
controlling at least one of a driving component or braking component of the vehicle according to the determined at least one of speed control parameter or braking force control parameter of the vehicle.

5. The method according to claim 1, wherein the performing the intelligent driving control on the vehicle according to the determined category of the pavement scene comprises:
outputting prompt information according to the determined category of the pavement scene, the prompt information comprising at least one of the following information:
a speed control parameter of the vehicle, a braking force control parameter of the vehicle, or warning information.

6. The method according to claim 2, wherein the performing the intelligent driving control on the vehicle according to the determined category of the pavement scene comprises:
outputting prompt information according to the determined category of the pavement scene, the prompt information comprising at least one of the following information:
a speed control parameter of the vehicle, a braking force control parameter of the vehicle, or warning information.

7. The method according to claim 1, wherein the determining the category of the pavement scene in the pavement image according to the obtained pavement image comprises:
inputting the obtained pavement image into a neural network, and determining the category of the pavement scene in the pavement image by using the neural network, wherein the neural network is trained by using an image set composed of the pavement images marked with categories of pavement scenes.

8. The method according to claim 1, wherein before determining the category of the pavement scene in the pavement image according to the obtained pavement image, the method further comprises:
clipping the obtained pavement image to obtain a clipped pavement image, wherein a proportion of the pavement on which the vehicle travels to the clipped pavement image is greater than a proportion of the pavement on which the vehicle travels to the obtained pavement image; and
wherein the determining the category of the pavement scene in the pavement image according to the obtained pavement image comprises:
determining the category of the pavement scene in the pavement image according to the clipped pavement image.

9. An intelligent driving control apparatus, comprising: a processor; and a memory configured to store instructions executable by the processor,
wherein the processor is configured to:
obtain a pavement image of a pavement on which a vehicle travels;
determine a category of a pavement scene in the pavement image according to the obtained pavement image; and
perform an intelligent driving control on the vehicle according to the determined category of the pavement scene.

10. The apparatus according to claim 9, wherein the processor is configured to:
determine, according to the obtained pavement image, a probability that the pavement in the pavement image belongs to each of at least one category of pavement scene comprising: an asphalt pavement, a cement pavement, a desert pavement, a dirt pavement, a slippery pavement, an icy pavement, and a snowy pavement; and
determine the category of the pavement scene in the pavement image based on the probability that the pavement in the pavement image belongs to each of the at least one category of pavement scene.

11. The apparatus according to claim 9, wherein the processor is configured to:
determine at least one of a speed control parameter or a braking force control parameter of a vehicle according to the determined category of the pavement scene; and
control at least one of a driving component or braking component of the vehicle according to the determined at least one of speed control parameter or braking force control parameter of the vehicle.

12. The apparatus according to claim 10, wherein the processor is configured to:
determine at least one of a speed control parameter or a braking force control parameter of a vehicle according to the determined category of the pavement scene; and
control at least one of a driving component or braking component of the vehicle according to the determined at least one of speed control parameter or braking force control parameter of the vehicle.

13. The apparatus according to claim 9, wherein the processor is configured to output prompt information according to the determined category of the pavement scene, the prompt information comprising at least one of the following information:
a speed control parameter of the vehicle, a braking force control parameter of the vehicle, or warning information.

14. The apparatus according to claim 10, wherein the processor is configured to output prompt information according to the determined category of the pavement scene, the prompt information comprising at least one of the following information:
a speed control parameter of the vehicle, a braking force control parameter of the vehicle, or warning information.

15. The apparatus according to claim 9, wherein the processor is configured to input the obtained pavement image into a neural network, and determine the category of the pavement scene in the pavement image by using the neural network, wherein the neural network is trained by using an image set composed of the pavement images marked with categories of pavement scenes.

16. The apparatus according to claim 9, wherein the processor is further configured to:
before the category of the pavement scene in the pavement image is determined according to the obtained pavement image, clip the obtained pavement image to obtain a clipped pavement image, wherein a proportion of the pavement on which the vehicle travels to the clipped pavement image is greater than the proportion of the pavement on which the vehicle travels to the obtained pavement image; and
determine the category of the pavement scene in the pavement image according to the clipped pavement image.

17. A non-transitory computer storage medium, configured to store computer readable instructions, wherein the instructions, when being executed, cause to implement an intelligent driving control method, the method comprising:
obtaining a pavement image of a pavement on which a vehicle travels;
determining a category of a pavement scene in the pavement image according to the obtained pavement image; and
performing an intelligent driving control on the vehicle according to the determined category of the pavement scene.

18. The non-transitory computer storage medium according to claim 17, wherein the determining the category of the pavement scene in the pavement image according to the obtained pavement image comprises:
determining, according to the obtained pavement image, a probability that the pavement in the pavement image belongs to each of at least one category of pavement scene including: an asphalt pavement, a cement pavement, a desert pavement, a dirt pavement, a slippery pavement, an icy pavement, and a snowy pavement; and
determining the category of the pavement scene in the pavement image based on the probability that the pavement in the pavement image belongs to each of the at least one category of pavement scene.

19. The non-transitory computer storage medium according to claim 17, wherein the performing the intelligent driving control on the vehicle according to the determined category of the pavement scene comprises:
determining at least one of a speed control parameter or a braking force control parameter of a vehicle according to the determined category of the pavement scene; and
controlling at least one of a driving component or braking component of the vehicle according to the determined at least one of speed control parameter or braking force control parameter of the vehicle.

20. The non-transitory computer storage medium according to claim 17, wherein the performing the intelligent driving control on the vehicle according to the determined category of the pavement scene comprises:
outputting prompt information according to the determined category of the pavement scene, the prompt information comprising at least one of the following information:
a speed control parameter of the vehicle, a braking force control parameter of the vehicle, or warning information.
